(19) United States
(12) Patent Application Publication
(10) Pub. No.: US 2026/0061734 A1
(43) Pub. Date: Mar. 5, 2026

(54) METAL OR ALLOY FILM RELEASE BY LOW SUBLIMATION RELEASE LAYER FOR ELECTROCHEMICAL DEVICE

(71) Applicant: Elevated Materials US LLC, Santa Clara, CA (US)

(72) Inventors: Kankona S Roy, Bangalore (IN); Subramanya P. Herle, Mountain View, CA (US); Gopi Chandran RAMACHANDRAN, Mumbai (IN)

(73) Assignee: Elevated Materials US LLC, Santa Clara, CA (US)

(21) Appl. No.: 19/316,821

(22) Filed: Sep. 2, 2025

Related U.S. Application Data
(60) Provisional application No. 63/690,164, filed on Sep. 3, 2024.

(51) Int. Cl. B32B 37/00; B32B 7/06; B32B 15/04; B32B 37/06

(52) U.S. Cl. CPC B32B 37/025; B32B 7/06; B32B 15/04; B32B 37/06; B32B 2307/7376

(57) ABSTRACT

Embodiments of the present disclosure relate to methods and devices related to thin film alkali metal energy storage devices. The method for transferring an alkali metal layer includes disposing a release layer over a flexible substrate, the release layer including a low sublimation point, wherein the low sublimation point is less than 120° C., disposing the alkali metal layer onto the release layer, laminating the release layer and the alkali metal layer between the flexible substrate and a first flexible carrier, sublimating the release layer via a treatment source to transfer the alkali metal layer from the flexible substrate to the first flexible carrier, the treatment source operable to pattern the alkali metal layer, and peeling away the flexible substrate from the first flexible carrier.

### CROSS-REFERENCE TO RELATED APPLICATIONS

This application claims the benefit of U.S. Provisional Application No. 63/690,164 filed Sep. 3, 2024, which is incorporated herein by reference in its entirety.

### BACKGROUND

### Field

Implementations of the present disclosure generally relate to processes for transferring metal layers using release layers. In particular, implementations relate to methods using a release layer including a low sublimation point to deposit and transfer lithium from polymer substrates to receiving substrates.

### Description of the Related Art

Rechargeable electrochemical storage systems are increasing in importance for many fields of everyday life. High-capacity energy storage devices, such as lithium-ion (Li-ion) batteries and capacitors, are used in a growing number of applications, including portable electronics, medical, transportation, grid-connected large energy storage, renewable energy storage, and uninterruptible power supply (UPS). In each of these applications, the charge/discharge time and capacity of energy storage devices are parameters of consideration. In addition, the size, weight, and/or cost of such energy storage devices are also parameters to be considered. Further, low internal resistance is beneficial for high performance. The lower the resistance, the less restriction the energy storage device encounters in delivering electrical energy. For example, in the case of a battery, internal resistance affects performance by reducing the total amount of useful energy stored by the battery as well as the ability of the battery to deliver high current.

One method for manufacturing energy storage devices is roll-to-roll processing. Roll-to-roll processing often involves transferring the thin film of lithium from a polymer substrate to a carrier substrate during processing. However, conventional approaches suffer from low throughput and the challenges when depositing thin film lithium of different sizes over a substrate.

Therefore, there is a need for improved systems and methods.

### SUMMARY

Implementations of the present disclosure generally relate to processes for transferring metal layers using release layers. In particular, implementations relate to methods using a release layer including a low sublimation point to deposit and transfer lithium from polymer substrates to receiving substrates.

In one embodiment, a method for transferring an alkali metal layer is provided. The method for transferring an alkali metal layer includes disposing a release layer over a flexible substrate, the release layer including a low sublimation point, wherein the low sublimation point is less than 120° C., disposing the alkali metal layer onto the release layer, laminating the release layer and the alkali metal layer between the flexible substrate and a first flexible carrier, sublimating the release layer via a treatment source to transfer the alkali metal layer from the flexible substrate to the first flexible carrier, the treatment source operable to pattern the alkali metal layer, and peeling away the flexible substrate from the first flexible carrier.

In another embodiment, a method for transferring an alkali metal layer is provided. The method for transferring an alkali metal layer includes disposing a release layer over a flexible substrate, the release layer including a low sublimation point, disposing the alkali metal layer onto the release layer, laminating the release layer and the alkali metal layer between the flexible substrate and a first flexible carrier, sublimating the release layer via a treatment source to transfer the alkali metal layer from the flexible substrate to the first flexible carrier, and peeling away the flexible substrate from the first flexible carrier.

In another embodiment, a method for making an energy storage device is provided. The method for making an energy storage device includes disposing a release layer solution over a flexible substrate, the release layer solution including a release layer material with a low sublimation point and an alcohol, disposing the release layer solution including spreading the release layer solution over the flexible substrate to form a release layer, disposing an alkali metal layer onto the release layer, laminating the release layer and the alkali metal layer between the flexible substrate and a first flexible carrier, wherein the first flexible carrier is a current collector or an anode, sublimating the release layer via a treatment source to transfer the alkali metal layer from the flexible substrate to the first flexible carrier, and peeling away the flexible substrate from the first flexible carrier.

In another embodiment, an alkali metal-containing film stack for energy storage devices is provided. The alkali metal-containing film stack for energy storage devices including a flexible support layer, a release layer disposed over the flexible support layer capable of separating from the flexible support layer, the release layer comprising hexo-Fluro-isopropoxide (LiHFIP) or lithium Nona-Fluoro-Tertbutoxide (LiNFTB), an alkali metal layer disposed over the release layer, the alkali metal layer patterned according to a treatment source pattern, and a flexible carrier.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of scope, as the disclosure may admit to other equally effective embodiments.

FIG. 1 illustrates a side schematic view of a substrate processing system, according to one or more embodiments of the present disclosure.

FIG. 2A illustrates a schematic, cross-sectional view of a patterned alkali metal containing stack, according to one or more embodiments of the present disclosure.

FIG. 2B illustrates a schematic, cross-sectional view of an alkali metal containing stack, according to one or more embodiments of the present disclosure.

FIG. 3 is a process flow diagram of a method of transferring a uniform alkali metal layer between substrates, according to one or more embodiments of the present disclosure.

FIGS. 4A-4F are views of various stages of manufacturing an energy storage device according to the method of FIG. 3, according to one or more embodiments of the present disclosure.

To facilitate understanding, identical reference numerals have been used, where possible, to designate identical elements that are common to the figures. It is contemplated that elements and features of one implementation may be beneficially incorporated in other implementations without further recitation.

### DETAILED DESCRIPTION

Implementations of the present disclosure generally relate to processes for transferring metal layers using release layers. In particular, implementations relate to methods using a release layer including a low sublimation point to deposit and transfer lithium from polymer substrates to receiving substrates.

Transferring alkali metal (e.g., lithium) layers onto substrates is an important process in microfabrication of microelectronic devices and energy storage devices. Conventional methods of depositing and transferring lithium often involve the use of release layers. Conventional release layers often leave a release layer on a surface of the alkali metal layer of the layer stack after transfer. Such release layer materials are typically not compatible with end uses such as electrochemical devices as the materials can impede ion or electronic transport. For example, the residual release layer may cause surface roughness to the alkali metal layer. This can result in poor alkali metal layer quality after transfer and other issues. A method of transferring lithium layers that can be completed with a release layer at low sublimation point and provide adequate alkali metal transfer is described below. The method can be incorporated in a roll-to-roll tool and used in a roll-to-roll process.

Substrate independent direct transfer (SIDT) is a method for forming anode device stacks by transferring one or more layers including an alkali metal or alloy film, for example, a lithium metal film, to a substrate stack. The substrate stack, for example, includes a polymer substrate, a release layer, an alkali metal or alloy film, and a carrier substrate (e.g., a current collector or an anode). The already formed anode material can include or be, but is not limited to, graphite, silicon, silicon graphite, silicon oxide graphite, silicon, or combinations thereof. The current collector can include or be metalized plastic, copper, or combinations thereof. In SIDT processes, a release layer is formed on the flexible carrier. The release layer can be a material with a low sublimation point such as hexo-Fluro-isopropoxide (LiHFIP) or lithium Nona-Fluoro-Tertbutoxide (LiNFTB). A lithium film (or an alkali metal or alkali metal alloy layer) is formed over the release layer. The lithium film is transferred to a flexible substrate (e.g., a flexible copper substrate) by having the flexible carrier and the flexible substrate pass through a calendering unit, sublimating the release layer, and then peeling away the flexible carrier. Sublimating the release layer allows for a clean transfer of alkali metal from a polymer substrate (e.g., PET substrate) to a carrier substrate (e.g., an anode). The release layer is sublimated by a UV, thermal, or IR treatment. The sublimation allows for complete transfer of the lithium film from the flexible carrier to the flexible substrate (e.g., there is no (or only negligible) lithium left on the flexible carrier after the peeling operation).

In another embodiment, the UV, thermal, laser, or IR treatment is selectively applied allowing for patterned alkali metal to be transferred from the flexible carrier to the flexible substrate. For example, the alkali metal can be patterned to match the pattern of the anode material in a pre-lithiation process, such as lane coating, skip coating, and also directly onto a current collector. Any suitable pattern may be achieved, for example, a square, a triangle, a circle, etc. Once the flexible carrier is peeled away, lithium is deposited onto the flexible substrate where the UV, thermal, or IR treatment was applied. Lithium remains on the flexible carrier where the UV, thermal, or IR treatment was not applied. The flexible substrate may then go through further processing. For example, a cutting step to size the substrate based on the patterned alkali metal layer on the substrate.

It is noted that while the particular substrate on which some implementations described herein can be practiced is not limited, it is particularly beneficial to practice the implementations on flexible substrates, including for example, web-based substrates, panels and discrete sheets. The flexible substrate can also be in the form of a foil, a polymer film, or a thin plate.

It is also noted here that a flexible substrate or web as used within the implementations described herein can typically be characterized in that it is bendable. The term “web” can be synonymously used to the term “strip,” the term “flexible substrate,” or the term “flexible conductive substrate.” For example, the web as described in implementations herein can be a polymer material.

It is further noted that the methods and systems described may be used in forming single-sided electrode structures and double-sided electrode structures.

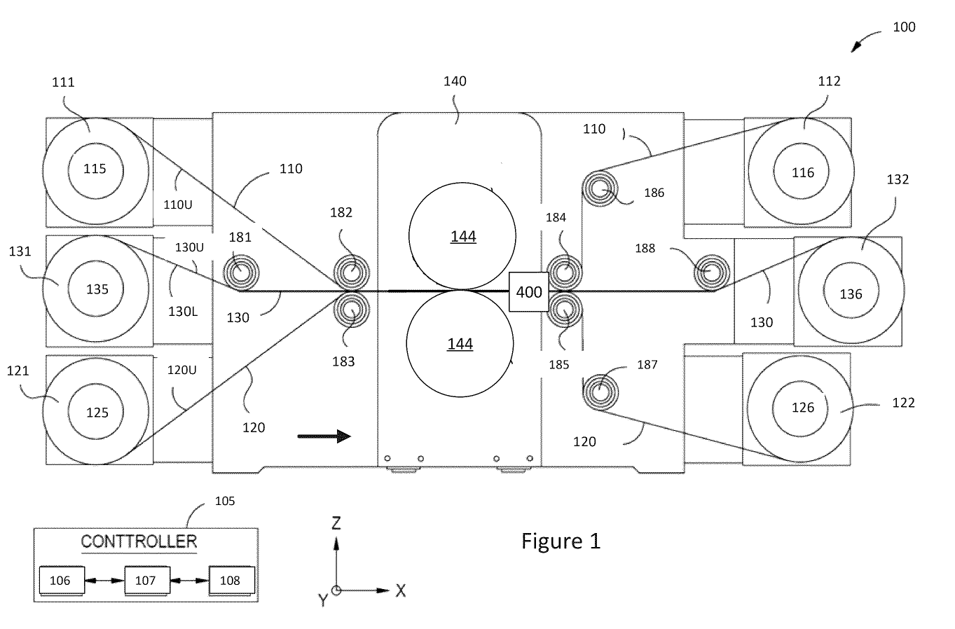

FIG. 1 shows a side cross-sectional view of a processing system 100 incorporating a calendering unit 140. The processing system 100 includes equipment for transferring alkali metal layer on a flexible substrate 130 to a first flexible carrier 110, so that the first flexible carrier 110 with alkali metal layer can be used as an electrode (e.g., anode) in a lithium-ion battery. The processing system 100 includes a calendering unit 140 to laminate the alkali metal layer on the flexible substrate 130 to the flexible carriers (e.g., the first flexible carrier 110 and the second flexible carrier 120). The calendering unit 140 includes two calendering rollers 144. For example, pressure is applied to the flexible substrate 130 and the flexible carriers (e.g., the first flexible carrier 110 and the second flexible carrier 120) to laminate an alkali metal and transfer the alkali metal layer from the flexible substrate 130 to the first flexible carrier 110. The pressure applied may be hydraulic pressure. The calendering unit 140 may include two calendering rollers 144 that are heated.

The processing system 100 includes a flexible substrate supply hub 135. A supply roll 131 of the flexible substrate 130 is positioned on the flexible substrate supply hub 135. In some embodiments, the flexible substrate 130 can be or include one or more of a polymer material, such as such as polyethylene terephthalate (PET), polyethylene naphthalate (PEN), polyimide (PI), or combinations thereof. A release layer (not shown in FIG. 1) is disposed on the upper surface 130U of the flexible substrate 130. An alkali metal or alkali metal alloy layer (e.g., a lithium layer) is disposed over the release layer (not shown in FIG. 1). The flexible substrate 130, the release layer 210, and the alkali metal layer 220 form a layer stack 410 on the upper surface 130U of the flexible substrate faces at least a first flexible carrier 110, so that the lithium layer faces the lower side 110U of the first flexible carrier 110. The layer stack 410 is conveyed through the calendering unit 140. The upper surface 130U of the flexible substrate 130 is on an opposite side relative to a lower surface 130L of the flexible substrate 130. The upper surface 130U is also referred to as the first surface or the first side of the flexible substrate 130 while the lower surface is also referred to as the second surface or the second side of the flexible substrate 130.

In other examples, a release layer (not shown in FIG. 1) is disposed on the lower surface 130L of the flexible substrate 130. An alkali metal or alkali metal alloy layer (e.g., a lithium layer) is disposed over the release layer (not shown in FIG. 1). The flexible substrate 130, the release layer 210, and the alkali metal layer 220 form a layer stack 410 on the upper surface 130U of the flexible substrate faces at least a first flexible carrier 110, so that the alkali metal layer faces the lower side 110U of the first flexible carrier 110. For example, a layer stack 410 is deposited on the upper surface 130U and the lower surface 130L of the flexible substrate 130.

The processing system 100 includes a first flexible carrier supply hub 115. A supply roll 111 of the first flexible carrier 110 is positioned on the first flexible carrier supply hub 115. In some embodiments, the first flexible carrier 110 can be or include one or more of copper, graphite, silicon, silicon graphite, silicon oxide graphite, silicon, metalized plastic, or other materials. In certain embodiments, the first flexible carrier 110 is an anode.

The processing system 100 optionally includes a second flexible carrier supply hub 125. A supply roll 121 of the second flexible carrier 120 is positioned on the second flexible carrier supply hub 125. In some examples, the second flexible carrier 120 can be formed of a same material (e.g., copper) as the first flexible carrier 110.

The lithium films on the first flexible carrier 110 and the second flexible carrier 120 can be formed of lithium metal, other alkali metals, or an alloy including an alkali metal. The processing system 100 further includes the calendering unit 140. The calendering unit 140 includes two calender rollers 144.

The flexible carriers (e.g., the first flexible carrier 110 and the second flexible carrier 120) and the flexible substrate 130 is arranged to be conveyed along a path that extends between the calendering rollers 144. In other examples, the first flexible carrier 110, the second flexible carrier 120, and the flexible substrate 130 are arranged to be conveyed along a path that extends between the calendering rollers 144. The flexible substrate 130 is positioned between the first flexible carrier 110 and the second flexible carrier 120 when the first flexible carrier 110, the second flexible carrier 120, and the flexible substrate 130 are conveyed between the calender rollers 144. The calender rollers 144 exert a high amount of pressure on the first flexible carrier 110, the second flexible carrier 120. The pressure causes the release layer 210 and the alkali metal layer 220 on the upper surface 130U of the flexible substrate 130 to laminate to the first flexible carrier 110 to form a layer stack 410. In embodiments including a second flexible carrier 120, the pressure causes the release layer 210 and the alkali metal layer 220 to laminate to the upper side 120U of the second flexible carrier 120.

A treatment source 400 is positioned adjacent to the calendering unit 140 and below the layer stack 410. The treatment source 400 may be a UV treatment, a thermal treatment, or an IR treatment. The treatment source 400 applies a treatment to at least the lower surface 130L of the flexible substrate 130. In some examples, the treatment source 400 applies the treatment to the upper surface 130U of the flexible substrate 130. Additionally or alternatively, the treatment source 400 may apply a treatment to a side of a flexible carrier (e.g., the first flexible carrier 110 or the second flexible carrier 120).

The processing system 100 includes a first flexible carrier pickup hub 116. A pickup roll 112 of the first flexible carrier 110 is positioned on the first flexible carrier pickup hub 116. The first flexible carrier 110 includes a patterned alkali metal layer 220a on the lower side 110U of the first flexible carrier 110. The patterned alkali metal layer 220a is patterned on the first flexible carrier 110 and is wound onto the first flexible carrier pickup hub 116.

The processing system 100 includes a second flexible carrier pickup hub 126. A pickup roll 122 of the second flexible carrier 120 is positioned on the second flexible carrier pickup hub 126. The second flexible carrier 120 includes a patterned alkali metal layer 220a on the upper side 120U of the second flexible carrier 120. The patterned alkali metal layer 220a on the second flexible carrier 120 and is wound onto the second flexible carrier pickup hub 126.

The processing system 100 includes a flexible substrate pickup hub 136. A pickup roll 132 of the flexible substrate 130 is positioned on the flexible substrate pickup hub 136. The flexible substrate 130, may include residual alkali metal layer 220b and release layer 210 on at least the upper surface 130U and optionally the lower surface 130L of the flexible substrate 130.

The processing system 100 further includes a plurality of rollers 181-188. In some embodiments, each of the rollers 181-188 can be passive rollers. The rollers 181-188 can assist in applying proper tension to and assist in changing the direction of the flexible carriers (e.g., the first flexible carrier 110 and the second flexible carrier 120) and the flexible substrate 130 during the movement of each of the flexible carriers (e.g., the first flexible carrier 110 and the second flexible carrier 120) and the flexible substrate 130 through the different portions of the processing system 100. Some of the rollers 181-188 can also assist in moving the flexible carriers (e.g., the first flexible carrier 110 and the second flexible carrier 120) closer to or further away from the flexible substrate 130. For example, the second roller 182 and third roller 183 assist in bringing the flexible carriers (e.g., the first flexible carrier 110 and the second flexible carrier 120) into contact with the flexible substrate 130 before the flexible carriers (e.g., the first flexible carrier 110 and the second flexible carrier 120) and the flexible substrate 130 are conveyed through the calendering unit 140. Additionally, the fourth roller 184 and fifth roller 185 provide a location at which tension can be applied to the flexible carriers (e.g., the first flexible carrier 110 and the second flexible carrier 120) to peel these flexible carriers (e.g., the first flexible carrier 110 and the second flexible carrier 120) away from the flexible substrate 130. In some examples, one or more of the rollers 181-188 can instead be a bar, such as metal bar, that can apply tension to the flexible carriers (e.g., the first flexible carrier 110 and the second flexible carrier 120) or the flexible substrate 130 during the movement of the flexible carriers (e.g., the first flexible carrier 110 and the second flexible carrier 120) or flexible substrate 130.

The processing system 100 can also include a controller 105 for controlling processes performed by the processing system 100. The controller 105 can be any type of controller used in an industrial setting, such as a programmable logic controller (PLC). The controller 105 includes a processor 107, a memory 106, and input/output (I/O) circuits 108. The controller 105 can further include one or more of the following components (not shown), such as one or more power supplies, clocks, communication components (e.g., network interface card), and user interfaces typically found in controllers for semiconductor equipment.

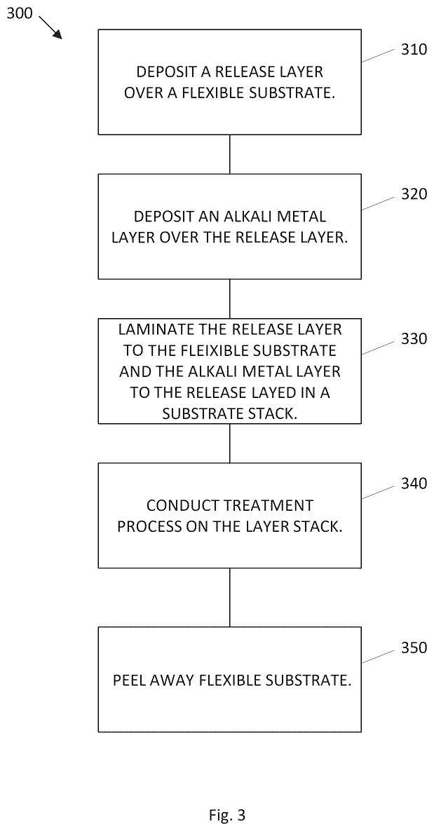

The processor 107 is configured to execute various programs stored in the memory 106, such as a program configured to execute the method 300 described below in reference to FIG. 3. During execution of these programs, the controller 105 can communicate to I/O devices through the I/O circuits 108. For example, during execution of these programs and communication through the I/O circuits 108, the controller 105 can control outputs (e.g., the actuators connected to the different hubs and the calendering unit 140). The memory 106 can further include various operational settings used to control the processing system 100. For example, the settings can include speed settings for the actuators connected to the hubs.

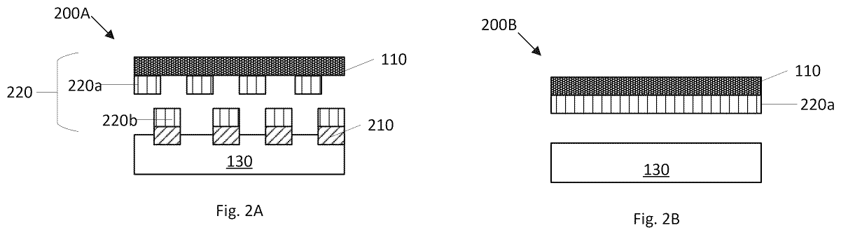

FIG. 2A illustrates a schematic, cross-sectional view of a patterned alkali metal containing layer stack 200A. FIG. 2B illustrates a schematic, cross-sectional view of a uniform alkali metal containing layer stack 200B. The patterned alkali metal containing layer stack 200A and the uniform alkali metal containing layer stack 200B both include a first flexible carrier 110 (e.g., a current collector or an anode) and an alkali metal layer 220 (e.g., a lithium layer). The already formed anode material can include or be, but is not limited to, graphite, silicon, silicon graphite, silicon oxide graphite, silicon, or combinations thereof. The current collector can include or be metalized plastic, copper, or combinations thereof. The alkali metal layer 220 can include or be an alkali metal alloy. The alkali metal layer 220 thickness is about 1 um to about 20 um.

As shown in FIG. 2A, the patterned alkali metal containing layer stack 200A includes a customized size or shape of the alkali metal layer 220. For example, the patterned alkali metal layer 220a can be patterned to match the pattern of the anode material in a pre-lithiation process, such as lane coating, skip coating, and also directly onto a current collector. Any suitable pattern may be achieved, for example, a square, a triangle, a circle, etc. As shown in FIG. 2B, the uniform alkali metal containing layer stack 200B is transferred as a uniform layer onto the first flexible carrier 110.

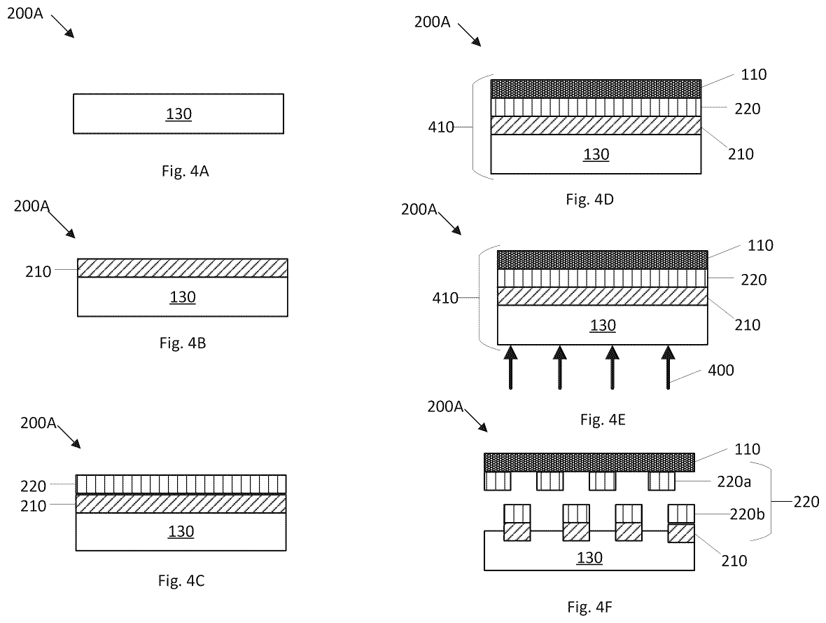

FIG. 3 is a process flow diagram of a method 300 of forming a patterned alkali metal containing layer stack 200A and transferring an alkali metal layer 220 between substrates (e.g., the first flexible carrier 110 and the flexible substrate 130). FIGS. 4A-4F are views of various stages of manufacturing an energy storage device according to method 300. The processing system 100 described herein can be used to mechanically transfer the alkali metal layer 220 from a flexible substrate 130 to a first flexible carrier 110.

At operation 310, a release layer 210 is deposited over the flexible substrate 130. As seen in FIG. 4A, the flexible substrate 130 includes no additional coatings or layers. The flexible substrate 130 may be a web-based substrate, a panel or a discrete sheet. The flexible substrate 130 can also be in the form of a foil, a polymer film, or a thin plate. The flexible substrate 130 may include a plastic material such as polyethylene terephthalate (PET). As shown in FIG. 4B, the release layer 210 is deposited so that it covers the flexible substrate 130 completely. The release layer 210 includes a release layer material with a low sublimation point such as hexo-Fluro-isopropoxide (LiHFIP) or lithium Nona-Fluoro-Tertbutoxide (LiNFTB). For example, the release layer 210 includes a sublimation point of about 120° C. or less. For example, about 60° C. to about 100° C. Before the deposition at operation 310, the release layer 210 material (e.g., LiHFIP or LINFTB) is combined with about 10% by weight isopropyl alcohol (IPA), about 20% by weight IPA, or about 30% by weight IPA to form a release layer solution. Additionally or alternatively the release layer 210 material may be combined with other alcohols such as ethanol and butanol. When ethanol or butanol are combined with the release layer 210 the mixture may be heated to about 50° C. for about 1 hour to dissolve the release layer 210 material into the alcohol. The release layer solution is spin coated, spray coated, slot-die coated, reverse comma-bar coated, kiss coated, mayer-rod coated, doctor blade coated, or gravure coated on the flexible substrate 130.

A solvent evaporation process is conducted on the flexible substrate 130 and the release layer solution. A controlled solvent evaporation process allows for elimination of coating defects such as uncoated patches, voids, or pin-windows that form during rapid evaporation. For example, the flexible substrate 130 and the release layer solution are heated (e.g., baked) at a temperature lower than the sublimation temperature of the release layer material. For example, if the sublimation temperature is 100° C., the heating temperature is about 70° C. to about 80° C. Further, for example, solvent evaporation process may occur for about 10 minutes to about 60 minutes. For example, the flexible substrate 130 and the release layer solution are soft baked at about 50 C for about 1 hour in a hot air oven to form the release layer 210. In other embodiments, the release layer 210 is deposited via vacuum thermal evaporation. The release layer 210 is about 200 nm or less. For example, the release layer may be about 50 nm, or about 100 nm, or about 150 nm. The thickness of the release layer 210 is dependent on the weight percent of release layer material combined in the alcohol solution. For example, a 5-10 weight percent of release layer material in an IPA solution forms a release layer 210 with a thickness of 100 nm. In some examples, a second release layer (not pictured) is deposited on a lower surface 130L of the flexible substrate 130. For example, the flexible substrate 130 includes a release layer 210 on the upper surface 130U, and the flexible substrate 130 includes a second release layer (not pictured) on the lower surface 130L.

At operation 320, as shown in FIG. 4C, an alkali metal layer 220 is deposited over the release layer 210. The alkali metal layer 220 includes alkali metals (e.g., lithium) or alkali metal alloys. The alkali metal layer 220 may be deposited under vacuum. The alkali metal layer 220 may be deposited via a physical vapor deposition process, for example, an evaporation process or a sputtering process. The evaporation process may be an electron beam evaporation process or a thermal evaporation process. In certain embodiments, a second alkali metal layer (not pictured) is deposited on a lower surface 130L of the flexible substrate 130 over a second release layer (not pictured). For example, the flexible substrate 130 includes a release layer 210 and an alkali metal layer 220 on the upper surface 130U, and the flexible substrate 130 includes a second release layer (not picture) and a second alkali metal layer (not pictured) on the lower surface 130L.

At operation 330, as shown in FIG. 4D, the processing system 100 conveys the flexible substrate 130, including the release layer 210 and the alkali metal layer 220, and a first flexible carrier 110 towards the calendering unit 140 from corresponding supply hubs 115 and 135. The first flexible carrier 110 may be a current collector or an anode. The already formed anode material can include or be, but is not limited to, graphite, silicon, silicon graphite, silicon oxide graphite, silicon, or combinations thereof. The current collector can include or be metalized plastic, copper, or combinations thereof. The flexible substrate 130, the release layer 210, the alkali metal layer 220, and the first flexible carrier 110 are conveyed through the calendering unit 140 and through the calendering rollers 144. The calendering rollers 144 laminate the flexible substrate 130 including the release layer 210 and the alkali metal layer 220 and a first flexible carrier 110 to form a layer stack 410 that is laminated. Optionally, a second flexible carrier 120 is conveyed through the calendering unit of the processing system 100 so that a layer stack 410 is formed on both sides of the flexible substrate 130.

At operation 340, as shown in FIG. 4E, a treatment process is conducted on the layer stack 410 via a treatment source 400. The treatment source 400 may include the means to provide a UV treatment, a thermal treatment, a laser treatment, and/or an IR treatment. The treatment provided by the treatment source 400 includes a temperature of at least 50 C to sublimate the release layer 210. The temperature of the treatment may be any temperature that will cause sublimation of the release layer 210. For example, the treatment provided by the treatment source 400 may be about 80° C. to about 100° C. For example the treatment provided by the treatment source 400 may be about 60° C. The treatment source 400 supplies the treatment through the flexible substrate 130 from the lower surface 130L of the flexible substrate. The treatment process provided by the treatment source 400, as shown in FIG. 4E, is selectively applied to pattern the alkali metal layer 220 and transfer the alkali metal layer 220 to the first flexible carrier 110. For example, the patterned alkali metal layer 220a can be patterned to match the pattern of the anode material in a pre-lithiation process, such as lane coating, skip coating, and also directly onto a current collector. Any suitable pattern may be achieved, for example, a square, a triangle, a circle, etc. In other embodiments, the treatment source 400 is uniformly applied across the flexible substrate 130 to sublimate the release layer 210 completely, as shown in FIG. 2B resulting in a uniform alkali metal containing layer stack 200B. In embodiments including a layer stack 410 on both sides of the flexible substrate 130, the treatment source 400 is applied to lower surface 130L and the upper surface 130U of the flexible substrate 130 to sublimate the release layer 210.

At operation 350, as shown in FIG. 4F, the flexible substrate 130 is peeled away from the first flexible carrier 110 as the first flexible carrier 110 and the flexible substrate 130 are conveyed past the fourth roller 184 and the fifth roller 185, as shown in FIG. 1. In embodiments including a second flexible carrier 120, the second flexible carrier 120 is peeled away from the flexible substrate 130 simultaneously to the first flexible carrier 110. The first flexible carrier, the flexible substrate 130, and the optional second flexible carrier 120 are conveyed to the respective pickup hub 116, 136, 126. As shown in FIG. 4F, the first flexible carrier 110 is patterned with a patterned alkali metal layer 220a according to the treatment source 400 pattern. In this example, the first flexible carrier 110 includes a skip transfer pattern of the patterned alkali metal layer 220a. The sublimation of the release layer 210 via the treatment source 400 allows for the patterned alkali metal layer 220a to peel away from the flexible substrate 130 with a low release force. Further, the sublimation of the release layer 210 via the treatment source 400 allows for a clean release of the patterned alkali metal layer 220a from the flexible substrate 130 (e.g., no, or negligible, residue of release layer 210 left on the patterned alkali metal layer 220a after transfer to the first carrier substrate). Further, as shown in 4F, after the first flexible carrier 110 is peeled away from the layer stack 410, a pattern of the release layer 210 and a residual alkali metal layer 220b remains on the flexible substrate 130 (e.g., the treatment was not applied where residual alkali metal layer 220b and the release layer 210 remains on the flexible substrate 130). In embodiments including a layer stack 410 on both sides of the flexible substrate 130, a pattern of the release layer 210 and the residual alkali metal layer 220b remains on both sides of the flexible substrate 130. In embodiments including a uniform treatment process via the treatment source 400 applied across the flexible substrate 130, the alkali metal layer 220 completely transfers from the flexible substrate 130 to the first flexible carrier 110. Further, the release layer 210 will completely sublimate, as shown in FIG. 2B.

In some embodiments, which may be combined with other embodiments, the first flexible carrier 110 (and in certain embodiments the second flexible carrier 120) including the alkali metal layer 220 may undergo further processing. For example, a cutting step may be performed on the first flexible carrier 110 based on the pattern of the alkali metal layer 220.

Overall, the various embodiments of the present disclosure relate to processes for transferring alkali metal layers using release layers. Which typically employ a release layer deposited over a substrate and a thin alkali metal layer disposed over the release layer before being laminated with another substrate (e.g., an anode). Roll-to-roll processing often involves pretreated substrates that include ineffective chemical layers and rolls with certain widths to be economical. The rolls coated with the alkali metal layer may be resized to achieve a targeted roll width or size. The transferring of the alkali metal layer is more economical if residual release layer does not remain attached to the alkali metal layer after processing. Further, shaping the alkali metal layer to different sizes and widths over the substrate allows for customization used in a roll-to-roll application.

In the Summary and in the Detailed Description, and the Claims, and in the accompanying drawings, reference is made to particular features (including method operations) of the present disclosure. It is to be understood that the disclosure in this specification includes all possible combinations of such particular features. For example, where a particular feature is disclosed in the context of a particular aspect, implementation, or example of the present disclosure, or a particular claim, that feature can also be used, to the extent possible in combination with and/or in the context of other particular aspects and implementations of the present disclosure, and in the present disclosure generally.

Other tools capable of performing high rate deposition processes may also be adapted to benefit from the implementations described. In addition, any system enabling the deposition processes described can be used to advantage. The apparatus description described is illustrative and should not be construed or interpreted as limiting the scope of the implementations described. It should also be understood that although described as a roll-to-roll process, the implementations described may also be performed on discrete substrates.

Implementations and all of the functional operations described in this specification can be implemented in digital electronic circuitry, or in computer software, firmware, or hardware, including the structural means disclosed in this specification and structural equivalents thereof, or in combinations of them. Implementations described herein can be implemented as one or more non-transitory computer program products, i.e., one or more computer programs tangibly embodied in a machine readable storage device, for execution by, or to control the operation of, data processing apparatus, e.g., a programmable processor, a computer, or multiple processors or computers.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. Processors suitable for the execution of a computer program include, by way of example, both general and special purpose microprocessors, and any one or more processors of any kind of digital computer.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The term “comprises” and grammatical equivalents thereof are used herein to mean that other components, ingredients, operations, etc. are optionally present. For example, an article “comprising” (or “which comprises”) components A, B, and C can consist of (i.e., contain only) components A, B, and C, or can contain not only components A, B, and C but also one or more other components. In addition, whenever a composition, an element or a group of elements is preceded with the transitional phrase “comprising” or grammatical equivalents thereof, it is understood that it is contemplated that the same composition or group of elements may be preceded with transitional phrases “consisting essentially of,” “consisting of,” “selected from the group of consisting of,” or “is” preceding the recitation of the composition, element, or elements and vice versa.

Where reference is made herein to a method comprising two or more defined operations, the defined operations can be carried out in any order or simultaneously (except where the context excludes that possibility), and the method can include one or more other operations which are carried out before any of the defined operations, between two of the defined operations, or after all of the defined operations (except where the context excludes that possibility).

While the foregoing is directed to implementations of the present disclosure, other and further implementations of the disclosure may be devised without departing from the basic scope thereof, and the scope thereof is determined by the claims that follow.

What is claimed is:

1. A method for transferring an alkali metal layer comprising:
disposing a release layer over a flexible substrate, the release layer including a low sublimation point, wherein the low sublimation point is less than 120° C.;
disposing the alkali metal layer onto the release layer;
laminating the release layer and the alkali metal layer between the flexible substrate and a first flexible carrier;
sublimating the release layer via a treatment source to transfer the alkali metal layer from the flexible substrate to the first flexible carrier, the treatment source operable to pattern the alkali metal layer; and
peeling away the flexible substrate from the first flexible carrier.

2. The method of claim 1, wherein the release layer comprises hexo-Fluro-isopropoxide (LiHFIP) or lithium Nona-Fluoro-Tertbutoxide (LiNFTB).

3. The method of claim 1, wherein the release layer has a thickness of about 50 nm to about 200 nm.

4. The method of claim 1, wherein the alkali metal layer has a thickness of about 1 μm to about 20 μm.

5. The method of claim 1, wherein the treatment source includes a UV treatment source, a thermal treatment source, a laser treatment source, and/or an IR treatment source.

6. The method of claim 1, wherein the treatment source is selectively applied to the release layer through the flexible substrate, causing a selective sublimation.

7. The method of claim 6, wherein the selective sublimation produces a patterned alkali metal transfer from the flexible substrate to the first flexible carrier.

8. The method of claim 1, wherein the treatment source is uniformly applied to the release layer through the flexible substrate, causing a uniform sublimation.

9. The method of claim 8, wherein the uniform sublimation allows for a uniform alkali metal transfer from the flexible substrate to the first flexible carrier.

10. A method for transferring an alkali metal layer comprising:
disposing a release layer over a flexible substrate, the release layer including a low sublimation point of about 60° C. to about 100° C.;
disposing the alkali metal layer onto the release layer;
laminating the release layer and the alkali metal layer between the flexible substrate and a first flexible carrier;
sublimating the release layer via a treatment source to transfer the alkali metal layer from the flexible substrate to the first flexible carrier; and
peeling away the flexible substrate from the first flexible carrier.

11. The method of claim 10, wherein the release layer comprised of hexo-Fluro-isopropoxide (LiHFIP) or lithium Nona-Fluoro-Tertbutoxide (LiNFTB).

12. The method of claim 10, wherein the alkali metal layer is a lithium layer.

13. The method of claim 10, further comprising a second release layer and a second alkali metal layer disposed over a second side of the flexible substrate.

14. The method of claim 13, further comprising:
laminating the second release layer and the second alkali metal layer between the second side of the flexible substrate and a second flexible carrier;
sublimating the release layer via the treatment source on the second side of the flexible substrate; and
peeling away the flexible substrate from the second flexible carrier.

15. The method of claim 10, wherein the treatment source performs at least one of a UV treatment, a thermal treatment, a laser treatment, or an IR treatment.

16. A method for making an energy storage device, comprising:
disposing a release layer solution over a flexible substrate, the release layer solution comprising a release layer material with a low sublimation point and an alcohol, wherein disposing the release layer solution comprises spreading the release layer solution over the flexible substrate to form a release layer;
disposing an alkali metal layer onto the release layer;
laminating the release layer and the alkali metal layer between the flexible substrate and a first flexible carrier, wherein the first flexible carrier is a current collector or an anode;
sublimating the release layer via a treatment source to transfer the alkali metal layer from the flexible substrate to the first flexible carrier; and
peeling away the flexible substrate from the first flexible carrier.

17. The method of claim 16, wherein the release layer material comprises hexo-Fluro-isopropoxide (LiHFIP) or lithium Nona-Fluoro-Tertbutoxide (LiNFTB).

18. The method of claim 16, wherein the release layer solution comprises isopropyl alcohol (IPA).

19. The method of claim 16, further comprising:
evaporating the alcohol from the release layer solution, wherein evaporating the alcohol from the release layer solution comprises heating the flexible substrate and the release layer to about 70° C. to about 80° C.

20. The method of claim 16, wherein the treatment source performs a UV treatment, a thermal treatment, a laser treatment, and/or an IR treatment.

21. An alkali metal-containing film stack for energy storage devices, comprising:
a flexible support layer;
a release layer disposed over the flexible support layer capable of separating from the flexible support layer, the release layer comprising hexo-Fluro-isopropoxide (LiHFIP) or lithium Nona-Fluoro-Tertbutoxide (LiNFTB);
an alkali metal layer disposed over the release layer, the alkali metal layer patterned according to a treatment source pattern; and
a flexible carrier.
